(19) United States
(12) Patent Application Publication
(10) Pub. No.: US 2010/0136273 A1
(43) Pub. Date: Jun. 3, 2010

(54) REACTIVELY-COUPLED ARTICLES AND RELATED METHODS

(76) Inventors: Miguel A. Prieto, Richterswil (CH); Peter Sandkuehler, Tarrangona (ES); Antonio Batistini, Wangen (CH); Sandra Hofmann, Hirzel (CH); Stephen F. Hahn, Midland, MI (US); Mohamed Esseghir, Monroe Township, NJ (US); Monika Plass, Buehl (DE); Mark F. Sonnenschein, Midland, MI (US); H. Craig Silvis, Midland, MI (US); Hamed Lakrout, Midland, MI (US); Kevin J. Bouck, Midland, MI (US); Muthu Subramanian, Singapore (SG); Jinder Jow, Pearland, TX (US); Thiam Aik Lim, Singapore (SG); Stephen Y. Cheng, Hong Kong (CN); Lester Yeong, Singapore (SG)

Correspondence Address: The Dow Chemical Company, Intellectual Property Section, P.O. Box 1967, Midland, MI, 48641-1967, US

(21) Appl. No.: 12/444,871

(22) PCT Filed: Oct. 9, 2007
(86) PCT No.: PCT/US07/80812

§ 371 Date: Jan. 7, 2010

(30) Foreign Application Priority Data
Oct. 13, 2006 (US) 11580402

(51) Int. Cl. B32B 27/36; B32B 1/08

(52) U.S. Cl. 428/36.91; 428/483

(57) ABSTRACT

The present invention is an article of construction formed from an article adhesively-bonded to a layering material through (a) reactive coupling of a functionalized nitroxide or (b) the adhesion of components in a polymer matrix made from or containing a polymer, an organic peroxide, and a functionalized nitroxide. The initial article may be expanded. It may also be polar or nonpolar. Similarly, the layering material may be polar or nonpolar. Other embodiments of the present invention are described, including other articles and methods for preparing the articles. The useful articles of the present invention include shoe outsoles and midsoles, paints, overmolded articles, weather stripping, gaskets, profiles, belts, hoses, tubes, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, automotive belts, hoses, tubes, conveyor belts, footwear, sporting goods, and filled articles.

### FIELD OF THE INVENTION

The present invention relates to the reactive coupling of polymeric articles via (a) reactive coupling of functionalized, nitroxide-grafted polymers wherein the functional group provides the coupling site or (b) the adhesion of components in a polymer matrix made from or containing a polymer, an organic peroxide, and a functionalized nitroxide.

### DESCRIPTION OF THE PRIOR ART

Nonpolar polyolefins are used to a minor degree for shoe sole and mid-sole applications due to their poor adhesion to polar substrates. Blends of nonpolar polyolefins and polar polymers (such as copolymers of ethylene and unsaturated esters) are also limited in their use for the same reason. Notably, blends containing ethylene/vinyl acetate copolymers may also limit the balance of properties of final product, for example, in the areas of abrasion, service temperature, grip, and flexibility.

Accordingly, there is a need for polyolefin-based materials having improved adhesion to substrates such as leather (natural and synthetic) and other polar materials. Moreover, the need extends to adhering those polyolefin-based materials to those substrates by using polyurethane adhesives, without the use of special primers (like UV curing systems) or special surface treatment (like corona treatment). In particular, it is desirable for the adhesive system to be solvent or water borne.

Additionally, the aforementioned need includes improving the useful life, stability, and strength of the adhesive bond. It also desirable that the adhesion be substantially independent of the underlying polymer's crystallinity.

Furthermore, it is desirable that the process for adhering the polyolefin-based materials to the substrate proceed as rapidly as possible.

### SUMMARY OF THE INVENTION

The present invention is an article of construction formed from an article adhesively-bonded to a layering material through (a) reactive coupling of a functionalized nitroxide or (b) the adhesion of components in a polymer matrix made from or containing a polymer, an organic peroxide, and a functionalized nitroxide. The initial article may be expanded. It may also be polar or nonpolar. Similarly, the layering material may be polar or nonpolar. Other embodiments of the present invention are described, including other articles and methods for preparing the articles.

The useful articles of the present invention include shoe outsoles and midsoles, paints, overmolded articles, weather stripping, gaskets, profiles, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, automotive belts, hoses, tubes, conveyor belts, footwear, sporting goods, and filled articles.

### DESCRIPTION OF THE INVENTION

In a first embodiment, the present invention is an article of construction prepared from (a) an article formed from a nitroxide-containing polymeric composition comprising a functionalized-nitroxide-grafted polymer wherein the functional group being a first functional group covalently-bonded to the nitroxide and available for reactively coupling to a second, complementary functional group; (b) an adhesive comprising a functionalized coupling agent having a second functional group capable of reactively coupling with the first functional group; and (c) a layering material adhesively-bonded to the formed article by reactively-coupling the second functional group of the adhesive with the first functional group of the functionalized-nitroxide-grafted polymer.

The functionalized-nitroxide-grafted polymer is prepared as the reaction product of a free-radical reaction of a functionalized nitroxide with a variety of polymers. Those polymers are preferably hydrocarbon-based and include such suitable polymers as ethylene/propylene rubbers, ethylene/alpha-olefin copolymers, ethylene homopolymers, propylene homopolymers, ethylene/unsaturated ester copolymers, ethylene/alpha-olefin/diene interpolymers (including ethylene/propylene/diene monomers), ethylene/styrene interpolymers, halogenated ethylene polymers, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof. The polymers may be nonpolar or polar.

With regard to the suitable ethylene polymers, the polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between 0.910 grams per cubic centimeter and 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between 0.850 grams per cubic centimeter and 0.940 grams per cubic centimeter and a melt index between 0.01 to 100 grams per 10 minutes as measured by ASTM 1238, condition I. Preferably, the melt index is between 0.1 to 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1-butene, 4-methyl-1-pentene, 1-hexene, and 1-octene.

Ultra-low density polyethylene and very low density polyethylene are known interchangeably. These polymers have a density between 0.870 grams per cubic centimeter and 0.910 grams per cubic centimeter. High density ethylene polymers are generally homopolymers with a density between 0.941 grams per cubic centimeter and 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between 0.850 grams per cubic centimeter and 0.970 grams per cubic centimeter. Preferably, the density is between 0.85 grams per cubic centimeter and 0.955 grams per cubic centimeter, more preferably, between 0.850 grams per cubic centimeter and 0.920 grams per cubic centimeter.

Suitable ethylene/alpha-olefin interpolymers include those interpolymers:
(a) having a Mw/Mn from 1.7 to 3.5, at least one melting point, Tm, in degrees Celsius, and a density, d, in grams/cubic centimeter, wherein the numerical values of Tm and d correspond to the relationship:

Tm>31 2002.9+4538.5(d)−2422.2(d)²; or
(b) having a Mw/Mn from 1.7 to 3.5, and is characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or
(c) being characterized by an elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of a cross-linked phase:

Re>1481-1629(d); or
(d) having a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/α-olefin interpolymer; or
(e) having a storage modulus at 25° C., G′(25° C.), and a storage modulus at 100° C., G′(100° C.), wherein the ratio of G′(25° C.) to G′(100° C.) is in the range of 1:1 to 9:1.

Other useful ethylene/alpha-olefin interpolymer may
(a) have a molecular fraction which elutes between 40° C. and 130° C. when fractionated using TREF, characterized in that the fraction has a block index of at least 0.5 and up to 1 and a molecular weight distribution, Mw/Mn, greater than 1.3; or
(b) have an average block index greater than zero and up to 1.0 and a molecular weight distribution, Mw/Mn, greater than 1.3.

The ethylene/α-olefin/diene interpolymers of the present invention have polymerized therein ethylene, at least one α-olefin (for example, a C3-C20 α-olefin monomer), and a diene (for example, a C4-C40 diene monomer). Preferably, the ethylene is present in an amount in the range of 20 mass percent to 90 mass percent as determined by ASTM D-3900.

The α-olefin may be either an aliphatic or an aromatic compound, and may contain vinylic unsaturation or a cyclic compound, such as styrene, p-methyl styrene, cyclobutene, cyclopentene, and norbornene, including norbornene substituted in the 5 and 6 position with C1-C20 hydrocarbyl groups. The α-olefin is preferably a C3-C20 aliphatic compound, preferably a C3-C16 aliphatic compound, and more preferably a C3-C10 aliphatic compound.

Preferred ethylenically unsaturated monomers include 4-vinylcyclohexene, vinylcyclohexane, and C3-C10 aliphatic α-olefins (especially propylene, isobutylene, 1-butene, 1-pentene, 1-hexene, 3-methyl-1-pentene, 4-methyl-1-pentene, 1-octene, 1-decene and 1-dodecene). A more preferred C3-C10 aliphatic α-olefin is selected from the group consisting of propylene, 1-butene, 1-hexene and 1-octene, and more preferably propylene.

The diene monomer can be a non-conjugated diolefin that is conventionally used as a cure site for cross-linking The nonconjugated diolefin can be a C6-C15 straight chain, branched chain or cyclic hydrocarbon diene. Illustrative nonconjugated dienes are straight chain acyclic dienes, such as 1,4-hexadiene and 1,5-heptadiene; branched chain acyclic dienes such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene, and mixed isomers of dihydromyrcene; single ring alicyclic dienes such as 1,4-cyclohexadiene, 1,5-cyclooctadiene and 1,5-cyclododecadiene; multi-ring alicyclic fused and bridged ring dienes such as tetrahydroindene, methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene and 5-cyclohexylidene-2-norbornene.

The diene is preferably a non-conjugated diene selected from the group consisting of ENB, dicyclopentadiene, 1,4-hexadiene, 7-methyl-1,6-octadiene, and preferably, ENB, dicyclopentadiene and 1,4-hexadiene, more preferably ENB and dicyclopentadiene, and even more preferably ENB. Most preferably, when the diene is ENB, it is present in an amount in the range from 0.3 mass percent to 20 mass percent measured according to ASTM D-6047.

The diene can be a conjugated diene selected from the group consisting of 1,3-pentadiene, 1,3-butadiene, 2-methyl-1,3-butadiene, 4-methyl-1,3-pentadiene, or 1,3-cyclopentadiene.

Preferably, the ethylene/α-olefin/diene interpolymer has a molecular weight distribution (Mw/Mn) from 1.1 to 5, more preferably from 1.2 to 4 and most preferably from 1.5 to 3. All individual values and subranges from 1.1 to 5 are included herein and disclosed herein.

Furthermore, when characterized by its Mooney Viscosity the ethylene/α-olefin/diene interpolymer preferably has a Mooney Viscosity, ML(1+4)@125° C. from 5 to 50, more preferably from 10 to 40, and even more preferably from 15 to 30 (ASTM D1646-06 (Alpha Technologies Rheometer MV 2000). All individual values and subranges from 5 to 50 are included herein and disclosed herein. Polymer Mooney Viscosity refers to the viscosity of the “neat” polymer absent any partitioning agent and oil.

Ethylene/styrene interpolymers useful in the present invention include substantially random interpolymers prepared by polymerizing an olefin monomer (that is, ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 5 to 50 percent by weight based on the weight of the copolymer, and is preferably in the range of 15 to 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of 0.5 to 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Examples of propylene polymers useful in the present invention include propylene homopolymers and copolymers of propylene with ethylene or another unsaturated comonomer. Copolymers also include terpolymers, tetrapolymers, etc. Typically, the polypropylene copolymers comprise units derived from propylene in an amount of at least 60 weight percent. Preferably, the propylene monomer is at least 70 weight percent of the copolymer, more preferably at least 80 weight percent.

Natural rubbers suitable in the present invention include high molecular weight polymers of isoprene. Preferably, the natural rubber will have a number average degree of polymerization of 5000 and a broad molecular weight distribution.

Useful styrene/butadiene rubbers include random copolymers of styrene and butadiene. Typically, these rubbers are produced by free radical polymerization or anionic solution polymerization. Styrene/butadiene/styrene block copolymers of the present invention are a phase-separated system. The styrene/ethylene/butadiene/styrene copolymers useful in the present invention are prepared from the hydrogenation of styrene/butadiene/styrene copolymers.

The polybutadiene rubber useful in the present invention is preferably a homopolymer of 1,4-butadiene. Preferably, the butyl rubber of the present invention is a copolymer of isobutylene and isoprene. The isoprene is typically used in an amount between 1.0 weight percent and 3.0 weight percent.

For the present invention, polychloroprene rubbers are generally polymers of 2-chloro-1,3-butadine. Preferably, the rubber is produced by an emulsion polymerization. Additionally, the polymerization can occur in the presence of sulfur to incorporate crosslinking in the polymer.

Preferably, the nitrile rubber of the present invention is a random copolymer of butadiene and acrylonitrile.

Other useful free-radical crosslinkable polymers include silicone rubbers and fluorocarbon rubbers. Silicone rubbers include rubbers with a siloxane backbone of the form —Si—O—Si—O—. Fluorocarbon rubbers useful in the present invention include copolymers or terpolymers of vinylidene fluoride with a cure site monomer to permit free-radical crosslinking.

Suitable functionalized nitroxides are hindered amine-derived stable organic free radicals and include derivatives of 2,2,6,6,-tetramethyl piperidinyl oxy (TEMPO). The first functional group is provided by the substituents of the nitroxide and available for reactively coupling to a second, complementary functional group. Preferably, hindered amine-derived stable organic free radicals are bis-TEMPOs, oxo-TEMPO, 4-hydroxy-TEMPO, an ester of 4-hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, 4-amine TEMPO, 4-isocyanate-TEMPO, or TEMPO derivatives containing primary hydroxyl groups.

Preferably, the functionalized nitroxide is present in an amount between 0.05 weight percent to 10.0 weight percent, more preferably between 0.1 weight percent to 5.0 weight percent. Even more preferably, it is present between 0.25 weight percent to 2.0 weight percent.

Generally, the functionalized nitroxide is grafted onto the previously described polymers to form the functionalized-nitroxide-grafted polymers by using free-radical inducing species such as organic peroxides and Azo free radical initiators or radiation such as e-beaming. Organic peroxides can be added via direct injection. These free-radical inducing species may be used in combination with other free-radical initiators such as bicumene, oxygen, and air. Oxygen-rich environments can also initiate useful free-radicals. Examples of useful organic peroxides include di-(2-t-butylperoxy-isopropyl)benzene, dicumyl peroxide, t-butyl peroxybenzoate, 1,1-di(tert-butylperoxy)-3,3,5-trimethylcyclohexane, 2,5-dimethyl-2,5-di(tert-butylperoxy)hexyne-3, and 2,5-dimethyl-2,5-di(tert-butylperoxy)hexane. When selecting an organic peroxide, the relevant heat of activation should be considered because the relevant heat of activation may affect the peroxide's suitability for the particular article or its preparation.

Preferably, the free-radical inducing species is present in an amount between 0.05 weight percent to 10.0 weight percent, more preferably between 0.1 weight percent to 5.0 weight percent. Even more preferably, it is present in an amount between 0.20 weight percent and 2.0 weight percent.

As alternative to organic peroxides, E-beam radiation, UV radiation, or temperature may be used to form the free radicals necessary for grafting the functionalized-nitroxide onto the polymer.

Preferably, the functionalized-nitroxide-grafted polymer was prepared under conditions of low shear rates and long residence times so that the resulting article can achieve desirable level of adhesions, but these parameters must be balanced against undesirable features such as premature crosslinking.

The composition for preparing the article identified as element (a), which composition comprises the functionalized-nitroxide-grafted polymer, may further comprise a blowing agent for yielding the article in an expanded form. The blowing agent can be a chemical or physical blowing agent. Preferably, the blowing agent will be a chemical blowing agent. An example of a useful chemical blowing agent is azodicarbonamide. Preferably, when the blowing agent is a chemical blowing agent, it is present in an amount between 0.05 to 6.0 phr. More preferably, it is present between 0.5 to 5.0 phr, even more preferably, between 1.5 to 3.0 phr.

Additionally, the organic peroxide or free-radical inducing species may be added in second amount or in an excess amount to achieve crosslinking of the functionalized-nitroxide-grafted polyolefin.

The composition for preparing the article identified as element (a), which composition comprises the functionalized-nitroxide-grafted polymer, may further comprise a cure booster or a coagent to aid in crosslinking the formed article. Useful cure boosters include polyvinyl agents and certain monovinyl agents such as alpha methyl styrene dimer, allyl pentaerythritol (or pentaerythritol triacrylate), TAC, TAIC, 4-allyl-2-methoxyphenyl allyl ether, and 1,3-di-isopropenylbenzene. Other useful cure boosters include compounds having the following chemical structures.

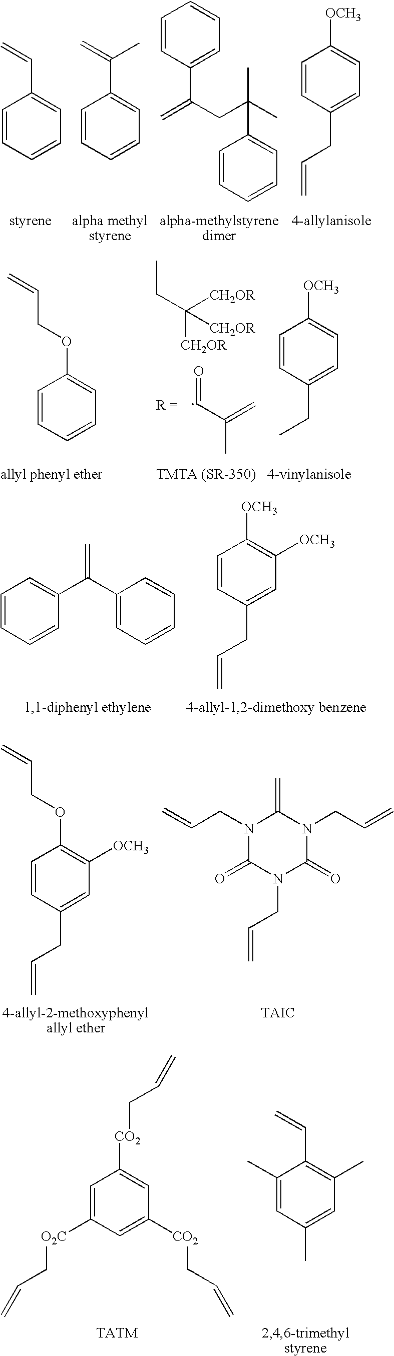

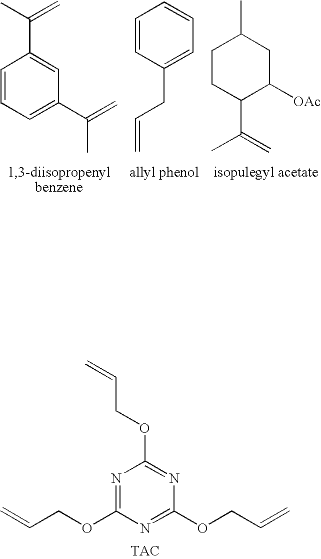

When the composition contains a cure booster, the cure booster is preferably present in an amount less than 5.0 phr. More preferably, it is present between 0.1 to 4.0 phr, even more preferably, between 0.2 to 3.0 phr.

The adhesive, comprising a functionalized coupling agent having a second functional group capable of reactively coupling with the first functional group of the functionalized-nitroxide-grafted polymer, includes a variety of adhesives. Notable, examples include isocyanate-based adhesives when the first functional group is a hydroxyl or amino group.

The layering material can be a variety of substrates. Suitable examples include polar and nonpolar materials, such as paint, coatings, films, leather (natural and synthetic), glass, fibers (natural and synthetic), wood composites, filled substrates, engineering thermoplastics, thermoplastic elastomers, thermoplastic vulcanizates, nanocomposites, reinforced cement, cord fabric, and non-wovens.

With regard to the cord fabric, it can be formed from a polyethylene terephthalate (PET). The polyester may further be treated with an adhesive, such as an adhesive composition comprising resorcinol, formaldehyde and vinyl pyridine latex. Examples of useful latex formulations include emulsions of styrene-butadiene rubber, acrylate resins, polyvinylacetate resins, neoprene rubber, chlororsulfonated polyethylene, and nitrile or hydrogenated nitrile rubbers. In a preferred embodiment, the adhesive comprises a latex. More preferably the adhesive further comprises resorcinol and formaldehyde. Even more preferably, the latex is a vinyl pyridine latex.

Notably, the substrate or layering material may comprise at least one component formed from polyester resins, polyamide resins, aramid resins, polyvinyl alcohol resins, acrylic resins, glass, cotton, carbon fiber, or combinations thereof.

When considering the article, the adhesive, and the layering material, the selection of conditions for adhering the article and the layering material can affect the quality of the adhesion. Accordingly, it is desirable to manage the heat of activation for the adhesion based upon such factors as the first functional group, the adhesive, and the second functional group.

The useful articles of the present invention include shoe outsoles and midsoles, paints, overmolded articles, weather stripping, gaskets, profiles, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, automotive belts, hoses, tubes, conveyor belts, footwear, sporting goods, and filled articles.

The embodiment is presently described by contemplating preparation of the functionalized-nitroxide-grafted polymer separately from promoting crosslinking of the polymer. It should be noted that in-situ grafting during the crosslinking of the polymer is considered within the scope of the present invention. This concurrent grafting and crosslinking is believed to enable elimination of a process step and may improve the process's efficiency.

In another alternate embodiment, the present invention is an article of construction prepared from (a) an article formed from a nitroxide-containing polymeric composition comprising a functionalized-nitroxide-grafted polymer wherein the functional group being a first functional group covalently-bonded to the nitroxide and available for reactively coupling to a second, complementary functional group and (b) an overmolding polymer matrix comprising an organic polymer having a second, complementary functional group capable of reactively-coupling with the first functional group of the functionalized-nitroxide-grafted polymer. The article described above with the first embodiment is equally suitable for use in this alternate embodiment.

The organic polymer can be a functionalized-derivative of a variety of organic polymers. Those organic polymers include the previously-described hydrocarbon-based polymers, including ethylene/propylene/diene monomers, ethylene/propylene rubbers, ethylene/alpha-olefin copolymers, ethylene homopolymers, propylene homopolymers, ethylene/unsaturated ester copolymers, ethylene/styrene interpolymers, halogenated ethylene polymers, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof.

Other useful functionalized organic polymers, depending upon the first functional group, include polyols, polyisocyanates, polyamines, and others.

When considering the article and the overmolding polymer matrix, the selection of conditions for reactively-coupling the article and the overmolding polymer matrix can affect the quality of the coupling bond. Accordingly, it is desirable to manage the heat of activation for the reactive coupling based upon such factors as the first functional group and the second functional group.

In yet another embodiment, the present invention can be a method for preparing a laminated article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting a layering material for adhesively-binding to the formed article; (c) applying an adhesive to the desired binding surface of (1) the formed article of construction or (2) the layering material, wherein the adhesive comprises a functionalized coupling agent having a second functional group capable of reactively coupling with the first functional group; (d) proximately placing the article of construction and the layering material such that the adhesive affixes the article and the layering material to each other; and (e) reactively-coupling the second functional group of the adhesive with the first functional group of the functionalized-nitroxide-grafted polymer to adhesively bind the layering material to the article.

In another embodiment, the present invention is a method for preparing a coated article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting a coating material for adhesively-binding to the formed article; (c) applying an adhesive to the desired binding surface of the formed article of construction, wherein the adhesive comprises a functionalized coupling agent having a second functional group capable of reactively coupling with the first functional group; (d) applying the coating material to the article's surface upon which the adhesive was applied in Step (c), and (e) reactively-coupling the second functional group of the adhesive with the first functional group of the functionalized-nitroxide-grafted polymer to adhesively bind the coating to the formed article.

In this embodiment the coating material can be any material desirable for adhering to the article. Suitable examples include paints, coverings, and insulative materials. The coating may contain a functional group suitable for reactively coupling with the first, the second, or both functional groups.

In another embodiment, the present invention is a method for preparing an overmolded article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting an overmolding polymer matrix comprising an organic polymer having a second, complementary functional group capable of reactively-coupling with the first functional group of the functionalized-nitroxide-grafted polymer; (c) applying the overmolding polymer matrix to the desired binding surface of the formed article of construction; and (d) reactively-coupling the second functional group of the overmolding polymer matrix with the first functional group of the functionalized-nitroxide-grafted polymer to bind the overmolding polymer matrix to the article.

In yet another embodiment, the present invention is an article of construction formed from an article adhesively-bonded to a layering material through the adhesion of components in a polymer matrix made from or containing a polymer, an organic peroxide, and a functionalized nitroxide. In this embodiment, the polymer matrix is used to form the article. The previously-described polymers, organic peroxides, and functionalized nitroxides are useful in this embodiment.

Specifically, the invention of this embodiment is an article of construction prepared from (a) an article formed from a polymer matrix made from or containing a polymer, an organic peroxide, and a functionalized nitroxide, wherein the functional group being a first functional group covalently-bonded to the nitroxide and available for reactively coupling to a second, complementary functional group; (b) an adhesive comprising a functionalized coupling agent having a second functional group capable of reactively coupling with the first functional group; and (c) a layering material adhesively-bonded to the formed article by reactively-coupling the second functional group of the adhesive with the first functional group of the polymer matrix. Alternatively, this embodiment includes an article of construction prepared from (a) an article formed from a polymer matrix made from or containing a polymer, an organic peroxide, and a functionalized nitroxide, wherein the functional group being a first functional group covalently-bonded to the nitroxide and available for reactively coupling to a second, complementary functional group and (b) an overmolding polymer matrix comprising an organic polymer having a second, complementary functional group capable of reactively-coupling with the first functional group of the functionalized-nitroxide-grafted polymer.

In a preferred embodiment, the functionalized-nitroxide-grafted polymer is a functionalized derivative of an ethylene/α-olefin/diene interpolymer. Herein, the functionalized-nitroxide-grafted polymer is prepared from a composition comprising from 90 to 99.8 weight percent of the ethylene/α-olefin/diene interpolymer; from 0.1 to 10 weight percent of a functionalized-nitroxide, and from 0.1 to 10 weight percent, of an organic peroxide. More preferably, the ethylene/α-olefin/diene interpolymer is present in an amount between from 94 to 97 weight percent. Also, more preferably, ethylene/α-olefin/diene interpolymers is an EPDM. In this preferred embodiment, the functionalized nitroxide is preferably present in an amount from 0.5 to 5 weight percent. The preferred functionalized nitroxide for this embodiment is 4-hydroxy-TEMPO. In this embodiment, the organic peroxide is preferably present in an amount from 0.5 to 3 weight percent.

### Examples

The following non-limiting examples illustrate the invention.

### Example 1 and Comparative Example 2

A functionalized nitroxide-grafted polymer was prepared from Affinity EG8200 ethylene/1-octene copolymer, 4-hydroxy-TEMPO, and Perkadox 1440™ di(tert-butylperoxyisopropyl)benzene. The ethylene/1-octene copolymer had a melt index of 5.0 decigrams per minute and a density of 0.87 grams per cubic centimeter and was available from The Dow Chemical Company. The 4-hydroxy-TEMPO was commercially available from A. H. Marks. Perkadox 1440™ di(tert-butylperoxyisopropyl)benzene was the peroxide used to initiate the free-radical grafting of the 4-hydroxy-TEMPO onto the ethylene/1-octene copolymer. Perkadox 1440™ di(tert-butylperoxyisopropyl)benzene had a nominal decomposition temperature (temperature at which 90 percent of the peroxide is decomposed in a 12-minute period) of 175 degrees Celsius and a half life of 94 minutes at 140 degrees Celsius. It was commercially available from Akzo Nobel Chemicals BV.

The functionalized nitroxide-grafted polymer was prepared in a lab twin screw extruder (Polylab) by feeding a dry blend of 5 percent by weight (“pbw”) 4-hydroxy-TEMPO, 10 pbw Perkadox 1440™ di(tert-butylperoxyisopropyl)benzene, and 85 pbw Affinity EG8200 ethylene/1-octene copolymer at 130 degrees Celsius to render a masterbatch. The masterbatch was diluted with additional ethylene/1-octene copolymer in a second run at 130 degrees Celsius to a composition containing 1 pbw 4-hydroxy-TEMPO and 2 pbw Perkadox 1440™ di(tert-butylperoxyisopropyl)benzene.

The resulting composition was reacted in the Polylab by raising the temperature towards 180 degrees Celsius at a feed rate of 2 kg/h and 150 rpm. The resulting functionalized nitroxide-grafted polymer (Example 1) was pelletized and compression molded at 120 degrees Celsius to render plaques suitable for further testing.

The Example 1 functionalized nitroxide-grafted polymer was evaluated for adhesion with the use of a polyurethane adhesive to a polyester fabric. The exemplified test specimen exhibited a grafting at the level of 0.138 weight percent as determined by Fourier Transform Infrared Analysis (“FTIR”). Example 1 demonstrated an adhesion of 5.738 N/mm as measured by DIN 53357 A. The comparative test specimen (Comparative Example 2) was prepared using the same copolymer, except it was not grafted with the functionalized-nitroxide. Comparative Example 2 did not demonstrate any adhesion.

### Solvent-Borne Adhesion

### Examples 3-5, 8-10, and Comparative Examples 6, 7, and 11

Test specimens were prepared of functionalized-nitroxide-grafted polymers made from ethylene polymers available from The Dow Chemical Company: (1) Affinity EG8200 and (2) Affinity PF 1140G. Affinity PF 1140G polyethylene had a melt index of 1.6 decigrams per minute and a density of 0.897 grams per cubic centimeter. The functionalized-nitroxide-grafted polymers were prepared using the same method described with regard to Example 1 above. The underlying substrates were leather strips.

A comparative example used thermoplastic polyurethane sheets made from Pellethane 2355-80AE thermoplastic polyurethane (which was available from The Dow Chemical Company) as the polymer rather than an ethylene polymer.

| Primer A | pbw |
|---|---|
| methyl-ethyl ketone | 100 |
| polyurethane adhesive (solvent borne) | 50 |
| poly-isocyanate crosslinker (solvent borne) | 25 |

| Adhesive B | pbw |
|---|---|
| polyurethane adhesive (solvent borne) | 100 |
| poly-isocyanate crosslinker (solvent borne) | 5 |

The split side of the leather was abraded with sandpaper rotating disk machine to unify and shorten the fibers. The polymer surfaces were abraded and roughened with sandpaper of grade 60 and subsequently wiped clean with toluene.

Primer A was applied to the polymer substrates with a brush two times and to the leather with a pipette soaking the leather. Polymer substrates were then dried in an oven at <50 degrees Celsius for 10 minutes. The leather samples are dried at <50 degrees Celsius only until they were dry.

After the substrates were allowed to cool down, Adhesive B was applied with a brush on both substrates. The Affinity EG 8200 polymer substrate was heated for 5 minutes at 90 degrees Celsius, the Affinity PF 1140 G polymer substrate was heated for 5 minutes at 115-120 degrees Celsius, and the leather substrate was heated for only 1 minute at 90 degrees Celsius. The thermoplastic polyurethane sheets were heated in the oven at 115 degrees Celsius for 5 minutes. The substrates were pressed against each other for good contact. Finally, they were pressed between two foams of 10-centimeter thickness in the hot press at 20 degrees Celsius and 10 bar for 1 min. The samples were left at least overnight for curing.

Delamination and adhesive forces, respectively, were measured on the Zwick Tensile Z010 model with a 10 kN load cell. The test speed was 100 mm/min and the cut specimen strips are 15×100 mm.

TABLE 1

| | Ex 3 | Ex 4 | Ex 5 | Com. Ex 6 | Com. Ex 7 |
|---|---|---|---|---|---|
| Affinity EG8200 | 100 | 100 | 100 | 100 | 100 |
| 4-hydroxy-TEMPO | 1 | 0.5 | 0.25 | 0 | 0 |
| Perkadox 1440 | 2 | 1 | 0.5 | 0 | 3.3 |
| Delamination force | 6.69 | 4.97 | 5.59 | 1.15 | 0.99 |
| [N/mm] | | | | | |

TABLE 2

| | | | | Com. |
|---|---|---|---|---|
| | Ex 8 | Ex 9 | Ex 10 | Ex 11 |
| thermoplastic | | | | 100 |
| polyurethane sheet | | | | |
| Affinity PF 1140 | 100 | 100 | 100 | 0 |
| 4-hydroxy-TEMPO | 0.5 | 1 | 0.5 | 0 |
| Perkadox 1440 | 1 | 1 | 0.6 | 0 |
| Delamination force | 4.04 | 4.00 | 4.49 | 3.96 |
| [N/mm] | | | | |

### Water-Borne Adhesion

### Examples 12-13

Test specimens were prepared of functionalized-nitroxide-grafted polymers made from ethylene polymers available from Affinity EG8200. The functionalized-nitroxide-grafted polymer was prepared using the same method described with regard to Example 1 above. The underlying substrates were leather strips.

| Adhesive C | pbw |
|---|---|
| polyurethane adhesive (water borne) | 100 |
| block poly-isocyanate (water borne) | 5 |

The surfaces of the polymer were abraded and cleaned with toluene. The leather was abraded. The polymer surface was primed with a thin layer of a polyisocyanate-diol prepolymer with a brush and dried at 75 degrees Celsius for 40 min. Adhesive C was brushed onto the leather surface and onto the polymer surface and both polymer and leather are dried for 1 hour at 40 degrees Celsius. Both were taken out of the oven, the oven was heated up to 90 degrees Celsius and polymer and leather are activated for 1.5 min at 90 degrees Celsius. They were then forced together with mild hammering and pressed in the hot press for 1 min at 20 degrees Celsius and 10 bar.

Delamination and adhesive forces, respectively, were measured on the Zwick Tensile Z010 model with a 10 kN load cell. The test speed was 100 mm/min and the cut specimen strips are 15×100 mm.

TABLE 3

| | Ex 12 | Ex 13 |
|---|---|---|
| Affinity EG8200 | 100 | 100 |
| 4-hydroxy-TEMPO | 1 | 1 |
| Perkadox 1440 | 2 | 2 |
| Delamination force [N/mm] | 4.77 | 5.31 |

### Over-Molding

### Examples 14-15 and Comparative Example 16

A reacting mixture of diol and isocyanate was applied to the surface of a functionalized material. The isocyanate was mixed with the diol with a ratio of 1.0 or 1.1 per functionality (excess of isocyanate) and poured in a handmade mold over the respective functionalized material.

Samples of functionalized material were primed with a polyisocyanate-diol prepolymer. The polyisocyanate-diol prepolymer was applied at room temperature, and the polymer was held at 70 degrees Celsius in an oven for 40 min. The cooled down samples were then over-molded. The adhesion was significant, and the interface could not be separated manually. Samples with untreated polyolefin could be separated from the polyurethane by hand.

TABLE 4

| | Ex 14 | Ex 15 | Com. Ex 16 |
|---|---|---|---|
| Affinity EG 8200 | 100 | 100 | 100 |
| 4-hydroxy-TEMPO | 0.5 | 1 | 0 |
| Perkadox 1440 | 0.5 | 1 | 0 |
| Polymers separable | No | No | Yes |
| by hand | | | |

### Functionalized-Nitroxide-Grafted Ethylene/Propylene/Diene Terpolymers

### Examples 17 and 18 and Comparative Example 19

Examples 17 and 18 was prepared from the following components and ratios. The EPDM had a molecular weight of 130,000, a density of 0.88, an ethylene content of 70 percent, 5-ethylidene-2-norbornene (ENB) content of 0.6 percent and a Mooney Viscosity (ML1+4) measured at 125 degrees Celsius of 20. It was commercially available from The Dow Chemical Company under the brand name NORDEL™. The 4-hydroxy-TEMPO was commercially available from A H Marks and Company Limited. The dicumyl peroxide was commercially available from Atofina/Arkema (Luperox™ DCSC).

| Component | Weight (grams) |
|---|---|
| EPDM | 96.4 |
| 4-Hydroxy TEMPO | 2.0 |
| Dicumyl peroxide | 1.6 |

The components for Example 17 applied a dry blend method and involved mixing EPDM, by itself, in Haake mixer at 100 degrees Celsius, for 10 minutes. Next, the above dry blend was added into the mixer, and the resulting composition was mixed for 10 minutes. During the mixing, the mixer temperature was increased to 180 degrees Celsius, and maintained at this temperature for a 10 minute mixing period. The composition was removed, and then placed in a two roll mill for blending with fillers, oil and additives.

The components for Examples 18 applied an addition method and involved mixing EPDM, by itself, in Haake mixer at 120° C., for 10 minutes, to melt the resin. Next, the 4-hydroxy-TEMPO was added into the mixer, and the composition was mixed for 10 minutes. Next, DCP was added into the mixer, and mixed the composition was mixed for a further 10 minutes. The mixer temperature was increased to 180° C., and maintained at this temperature for 10 minutes. The composition was removed, and then placed in a two roll mill (Well Shyang Machinery Co. Ltd., Model No. SYM-8-18) for blending with fillers, oil and additives.

The final formulations for Examples 17 and 18 and Comparative Example 19 are shown below. Each amount is in grams.

The carbon black was N550 carbon black, having iodine absorption of 42.5 g/kg and commercially available from D C Chemical Co., Ltd. Sunflex 2280 had a flash point of 312 degree Celsius and was commercially available from Japan Sun Oil Company Ltd. The zinc oxide (white seal grade) was commercially available from US Zinc The Sartomer SR-350 trimethylolpropanetrimethacrylate was available from Sartomer Company, Inc.

| | Comp. | | |
|---|---|---|---|
| Component | Ex. 19 | Ex. 17 | Ex. 18 |
| EPDM | 100 | | |
| Ex. 17 Grafted Polymer | | 100 | |
| Ex. 18 Grafted Polymer | | | 100 |
| Carbon Black | 50 | 50 | 50 |
| Sunflex 2280 | 10 | 10 | 10 |
| Zinc oxide | 5 | 5 | 5 |
| SR-350 | 1 | 1 | 1 |
| Dicumyl peroxide | 4 | 4 | 4 |
| Total | 170 | 170 | 170 |

As discussed above, the compound formulations were mixed using a two-roll mill at a temperature from 50-60° C., for 20-30 minutes, at a speed of 20 rpm in the front roll, and a speed of 16 rpm in the rear roll to form a sheet compound. The sheet produced was cooled for 24 hours.

The sheet compounds were bonded and cured with polyester cord (resorcinol formaldehyde latex treated polyester cord) using a compression molding cycle to form the crosslinked EPDM rubber and bonded cord. Each sheet compound (2-3 grams) was placed over a “4 cm×4 cm” area of the cord fabric to provide a sample for molding. This sample was compression molded at a temperature of 180 degrees Celsius, and a pressure of 700 psi (4.83 MPa), for a period of 2-3 minutes, to form the compression molded sample. The molded sample was cooled to ambient temperature and maintained at ambient temperature for 24 hours.

The curing properties of each unvulcanized composition was measured using a moving die rheometer (MDR) at 180 degrees Celsius for 30 minutes and according to ASTM D5289-95. The properties for vulcanized specimen of the compositions was measured according to the test method specified in Table 5.

The Bond/Peel Strength was measured by peeling the sheet compound away from the cord to provide a 30 mm separation length. Using a Zwick Universal Tester (Model No. Z010), the compressed sample was placed into two grips as follows: the peeled away sheet was placed in the upper grip, and the fabric cord was placed in the lower grip. The upper grip moved, while the lower grip remained stationary. With a tester speed of 125 mm/min, the sheet was pulled from the cord, until the distance between the grips reached 125 mm (this distance included the initial separation distance of 25 mm between the grips). The maximum force and the average force required to pull the sheet from the cord were recorded.

TABLE 5
Properties for Ex. 17 and 18, and Comp. Ex. 19

| Unvulcanized Properties | Comp. Ex. 19 | Ex. 17 | Ex. 18 |
|---|---|---|---|
| ML, dNm | 1.17 | 0.71 | 0.8 |
| MH, dNm | 21.92 | 18.61 | 19.47 |
| MH − ML, dNm | 20.75 | 17.9 | 18.67 |
| Ts2, minutes | 0.36 | 0.45 | 0.44 |
| T10, minutes | 0.36 | 0.44 | 0.44 |
| T90, minutes | 2.19 | 1.95 | 2.32 |
| T90 − T10, minutes | 1.83 | 1.51 | 1.88 |

Vulcanized Properties

| | | | |
|---|---|---|---|
| Tensile Strength, MPa | 13.91 | 4.19 | 17.83 |
| (ASTM D412-98a) | | | |
| Tear Strength Die C, KN/m | 31.39 | 43.77 | 43.98 |
| (ASTM D624-00) | | | |

Bond/Peel Strength

| | | | |
|---|---|---|---|
| Average Force, N/40 mm | 60.2 +/− 6.7 | Cohesive | Cohesive |
| | | Failure | Failure |
| Maximum Force, N/40 mm | 72.5 +/− 13.3 | | |

In Examples 17 and 18, cohesive failure occurred in the interpolymer, indicating that the interlayer adhesion between the EPDM and PET fabric was stronger than the molecular adhesion in the interpolymer. In contrast, Comparative Example 19 failed at the sheet-fabric interface, indicating that the adhesion between the interpolymer and fabric was relatively poor. This demonstrates that the peel strength of the EPDM grafted with 4-hydroxy-TEMPO is significantly and surprisingly better than the base resin EPDM.

### Functionalized-Nitroxide-Grafted EPDM (Direct Compounding): Ex. 20

Example 20 was prepared from the following components and ratios. The 4-hydroxy-TEMPO was added during the compounding step (two-roll mill) to generate an in-situ grafting and crosslinking of the polymer.

| Component | Weight (grams) |
|---|---|
| EPDM | 100 |
| 4-Hydroxy-TEMPO | 0.5 |
| Dicumyl peroxide (98 percent) | 5.5 |
| Carbon Black | 50 |
| Sunflex 2280 | 10 |
| Zinc Oxide | 5 |
| SR-350 | 1 |
| Total | 172 |

The test specimens of Example 20 were prepared as described for Examples 17 and 18 and Comparative Example 19. The tests were also performed in the same manner. The curing, mechanical, and adhesion properties are reported in Table 6.

TABLE 6
Curing, Mechanical and Adhesion Properties for Ex. 20

| Unvulcanized Properties | Ex. 20 |
|---|---|
| ML, dNm | 0.76 |
| MH, dNm | 22.84 |
| MH − ML, dNm | 22.08 |
| Ts2, minutes | 0.42 |
| T10, minutes | 0.42 |
| T90, minutes | 2.21 |
| T90 − T10, minutes | 1.79 |

Vulcanized Properties

| | |
|---|---|
| Tensile Strength, MPa (ASTM D412-98a) | 20.12 |
| Tear Strength Die C, KN/m (ASTM D624-00) | 39.86 |

Bond/Peel Strength with PET Cord

| | |
|---|---|
| Average Force, N | Could not |
| | initiate the peel |
| Maximum Force, N | — |

Table 6 shows that the peel test could not be preformed under the specified conditions on Example 20. This indicates a very strong adhesion between the grafted and crosslinked EPDM and the resorcinol formaldehyde latex treated polyester cord.

1. An article of construction prepared from
(a) an article formed from a nitroxide-containing polymeric composition comprising a functionalized-nitroxide-grafted polymer wherein the functional group being a first functional group covalently-bonded to the nitroxide and available for reactively coupling to a second, complementary functional group;
(b) an adhesive comprising a functionalized coupling agent having a second functional group capable of reactively coupling with the first functional group; and
(c) a layering material adhesively-bonded to the formed article by reactively-coupling the second functional group of the adhesive with the first functional group of the functionalized-nitroxide-grafted polymer.

2. An article of construction prepared from
(a) an article formed from a nitroxide-containing polymeric composition comprising a functionalized-nitroxide-grafted polymer wherein the functional group being a first functional group covalently-bonded to the nitroxide and available for reactively coupling to a second, complementary functional group and
(b) an overmolding polymer matrix comprising an organic polymer having a second, complementary functional group capable of reactively-coupling with the first functional group of the functionalized-nitroxide-grafted polymer.

3. The article of construction of claim 1, wherein the nitroxide-grafted polymer of the polymeric composition is a polyolefin or blends thereof.

4. The polymeric composition according to claim 3 wherein the nitroxide-grafted polymer being nonpolar.

5. The article of construction of claim 1, wherein the reactively-coupled bond is a urethane linkage.

6. The article of construction of claim 5 wherein the first functional group being a hydroxyl group or an isocyanate group.

7. The article of construction of claim 1, wherein the functionalized nitroxide being selected from the group of 4-hydroxy TEMPO, 4-amino TEMPO, 4-isocyanate TEMPO, and TEMPO derivatives containing primary hydroxyl groups.

8. The article of construction of claim 1, wherein the nitroxide-containing polymeric composition further comprises a blowing agent.

9. The article of construction of claim 1 wherein the layering material has a first surface for adhering to the formed article and that first surface being polar.

10. The article of construction of claim 1 wherein the layering material being selected from the group consisting of natural substrates, polar substrates, paint, coatings, films, fibers, composites, and metal substrates.

11-13. (canceled)

14. An article of construction prepared from
a. an article formed from a polymer matrix made from or containing a polymer, an organic peroxide, and a functionalized nitroxide, wherein the functional group being a first functional group covalently-bonded to the nitroxide and available for reactively coupling to a second, complementary functional group;
b. an adhesive comprising a functionalized coupling agent having a second functional group capable of reactively coupling with the first functional group; and
c. a layering material adhesively-bonded to the formed article by reactively-coupling the second functional group of the adhesive with the first functional group of the polymer matrix.

15. (canceled)

16. The article of claim 1, wherein the functionalized-nitroxide grafted polymer is a functionalized-nitroxide-grafted ethylene/α-olefin/diene interpolymer.

17. The article of claim 16, wherein the layering material comprises at least one component formed from a composition comprising a polyester.

18. The article of claim 16, wherein the layering material is coated with the adhesive, and comprises at least one component formed from a composition comprising a polyester.

19. The article of claim 17, wherein the adhesive comprises a latex.

20. The article of claim 19, wherein the adhesive further comprises resorcinol and formaldehyde.

21. The article of claim 20, wherein the latex is a vinyl pyridine latex.

22. The article of claim 20, wherein the functionalized-nitroxide-grafted ethylene/α-olefin/diene interpolymer is crosslinked.

23. A belt comprising at least one component formed from the article of claim 22.

24. A hose or tube comprising at least one component formed from the article of claim 22.

25. A fabric cord comprising at least one component formed from the article of claim 22.
